(19) United States
(12) Patent Application Publication
(10) Pub. No.: US 2003/0095676 A1
(43) Pub. Date: May 22, 2003

(54) Hearing aid device with frequency-specific amplifier settings

(76) Inventors: Shih-Hsorng Shen, Taipei City (TW); Shuenn-Tsong Young, Taipei City (TW); Weileun Fang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,099

(22) Filed: Nov. 16, 2001

(51) Int. Cl. H04R 25/00

(52) U.S. Cl. 381/316; 381/312

(57) ABSTRACT

A hearing aid device includes a microphone, an amplifier, and a speaker. The microphone has bandpass filters, which separate incoming acoustic signals into a multiple channels. Both the microphone and the speaker have a series of amplifying elements, each with a different amplification level. By choosing which amplifying elements to switch on in the microphone and the speaker, the wearer of the hearing aid device may adjust for different amplification levels in each channel.

### BACKGROUND OF INVENTION

1. Field of the Invention

The present invention relates to a hearing aid device, and more specifically to a hearing aid device with frequency-specific amplifier settings.

2. Description of the Prior Art

In essence, a hearing aid device is a miniature microphone and speaker which, when inserted into the ear, can amplify sounds that may normally be too low in amplitude for a hearing-impaired person to hear. One challenge in crafting hearing aids is that not all hearing-impaired people need amplification of sounds along the entire range of audible frequencies.

Please refer to FIG. 1. FIG. 1 is a block diagram of a prior art hearing aid. In a prior art hearing aid 10, acoustic signals enter an acoustic signal input device of the hearing aid, in this case, a microphone 12. The microphone 12 translates the acoustic signal into an electrical signal, which is then amplified by an amplifier 14 connected to the microphone 12. The amplifier 14 boosts the volume of the electrical signal and passes the amplified signal to an acoustic signal output device of the hearing aid 10, in this case, a speaker 16. The speaker 16 transforms the electrical signal back into an acoustic signal and plays the acoustic signal into the ear of the wearer. The wearer benefits from the increased volume of the acoustic signals, which makes up for loss in the wearer's hearing sensitivity. However, many of the hearing-impaired lose hearing only in very specific frequency ranges, and a hearing aid that does not address these special needs runs the risk of functioning improperly, even to the point of further damaging the hearing of the wearer.

### SUMMARY OF INVENTION

It is an object of the claimed invention to provide a hearing aid device with frequency-specific amplifier settings to solve the problems mentioned above.

In accordance with the claimed invention, a hearing aid device with frequency specific amplifier settings includes an acoustic signal input device, an amplifier, and an acoustic signal output device. The acoustic signal input device comprises a plurality of bandpass filters, which separate incoming acoustic signals into separate channels with distinct frequency ranges. The acoustic signal input device comprises a plurality of amplifying elements, which can be adjusted to amplify the electrical signals in different channels at different amplification levels. The acoustic signal input device then outputs the acoustic signals in the form of electrical signals and passes the electrical signals to an amplifier. The amplifier amplifies the electrical signals received from the acoustic signal input device and passes the electrical signals to the acoustic signal output device. The acoustic signal output device receives the electrical signals from the amplifier. The acoustic signal output device comprises a plurality of amplifying elements, which can be adjusted to amplify the electrical signal in different channels at different amplification levels. The acoustic signal output device then transforms the electrical signals into acoustic signals.

It is an advantage of the claimed invention that a different amplification level can be set for each frequency range so that the wearer of the hearing aid device can adjust the hearing aid device to compensate for the wearer's specific areas of hearing loss.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a block diagram of a hearing aid device according to the prior art.

FIG. 2 is a block diagram of a hearing aid device according to the present invention.

FIG. 3 is a block diagram of an acoustic signal input device of a hearing aid device according to the present invention.

FIG. 4 is a block diagram of an acoustic signal output device of a hearing aid according to the present invention.

FIG. 5 is a block diagram of a bandpass filter of an acoustic signal input devices according to the present invention.

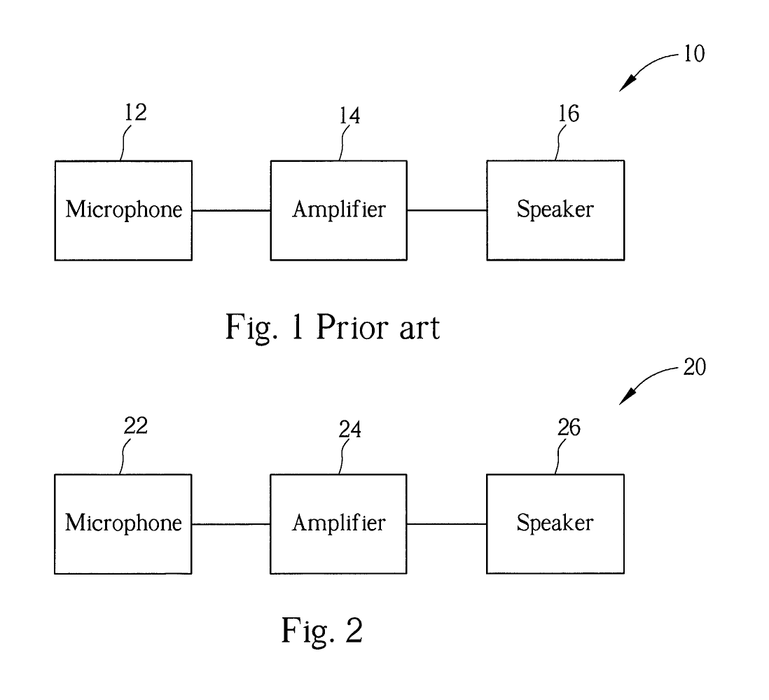

### DETAILED DESCRIPTION

Please refer to FIG. 2. FIG. 2 is a block diagram of a hearing aid device 20 according to the present invention. The hearing aid device 20 comprises an acoustic signal input device 22, an amplifier 24, and an acoustic signal output device 26, which are electrically connected in series. Acoustic signals enter the acoustic signal input device 22, are passed to the amplifier 24, and are played out of the acoustic signal output device 26.

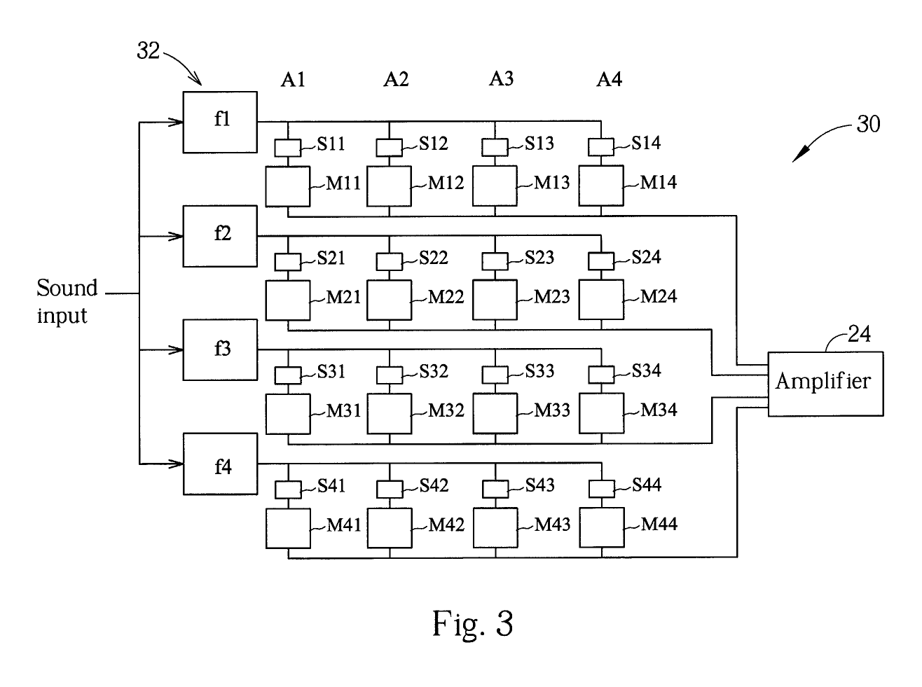

Please refer to FIG. 3. FIG. 3 is a block diagram of the acoustic signal input device 22 of the hearing aid device 20. The acoustic signal input device 22 comprises an acoustic signal input and an amplifying element array 30. The amplifying element array 30 comprises a plurality of bandpass filters 32, each of which is connected to a plurality of amplifying elements. The bandpass filters 32 filter incoming acoustic signals into distinct frequency ranges and convert the acoustic signal into an electrical signal, thereby creating a channel that carries electrical signals that fall within distinct frequency range. The amplifying elements amplify the electrical signals passed by the bandpass filters 32. A first bandpass filter f1 passes acoustic signals with a frequency between 800 and 1200 Hz. A second bandpass filter f2 passes acoustic signals with a frequency between 1200 and 2000 Hz. A third bandpass filter f3 passes acoustic signals with a frequency between 2000 and 2800 Hz. A fourth bandpass filter f4 passes acoustic signals with a frequency between 2800 and 3500 Hz. Each channel has a separate electrical output of the acoustic signal input device. The amplifying element array 30 shown in FIG. 3 and used as an example in this specification comprises channels, but it should be understood that the present invention is not limited to four channels, nor is the present invention limited to the frequency ranges given in the example.

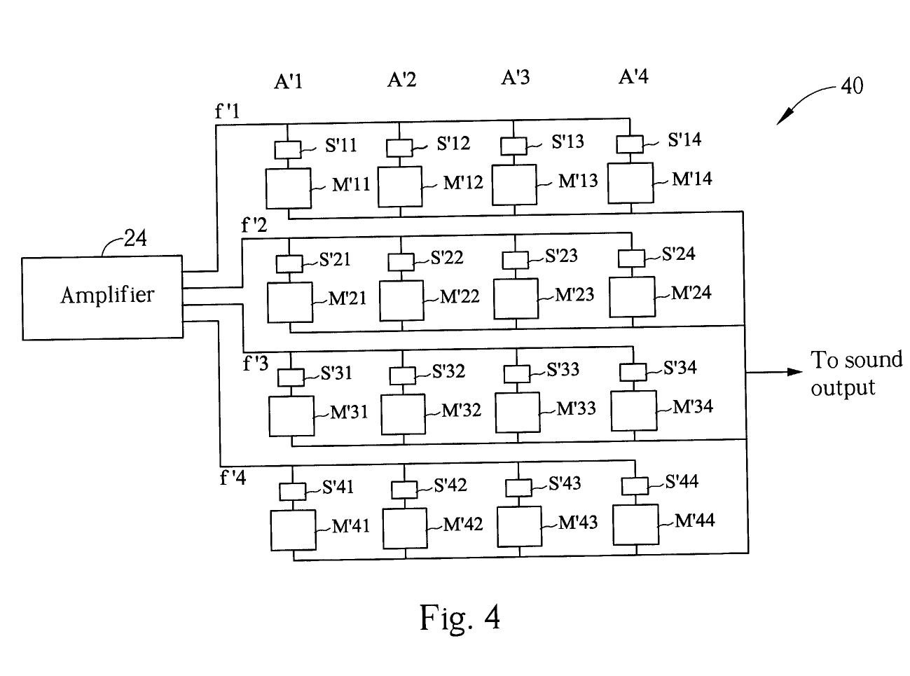

Please refer to FIG. 4. FIG. 4 is a block diagram of the acoustic signal output device 26 of the hearing aid 20. The acoustic signal output device 26 comprises an amplifying element array 40 and a plurality of signal inputs corresponding to different channels for receiving signals from the amplifier 24. A first channel f″1 carries signals with frequencies between 800 and 1200 Hz. A second channel f″2 carries signals with frequencies between 1200 and 2000 Hz. A third channel f″3 carries signals with frequencies between 2000 and 2800 Hz. A fourth channel f″4 carries signals with frequencies between 2800 and 3500 Hz. The amplification element array can be set to adjust the amplification level at which the signals in each channel is amplified. The level of amplification of each channel is independent from the level of amplification of the other channels. After the signals are amplified, they are converted back into an audible sound and played out of the acoustic signal output device. The amplification element array 40 shown in FIG. 4 and used as an example in this specification comprises four channels, but it should be understood that the present invention is not limited to four channels, nor is the present invention limited to the frequency ranges given in the example.

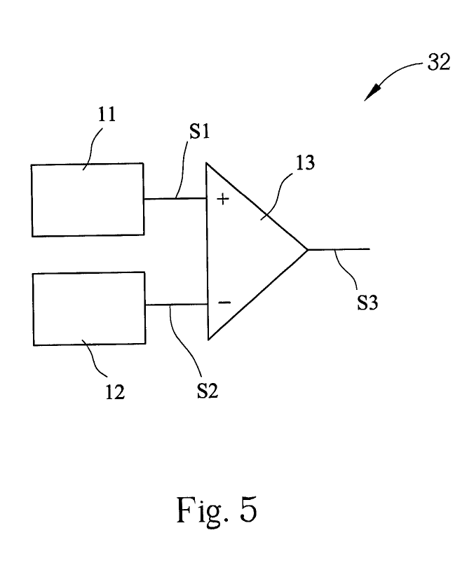

Please refer to FIG. 5. FIG. 5 is a block diagram of a bandpass filter 32 according to the present invention. The bandpass filter 32 comprises two acoustic receiving units 11, 12 with different resonant frequencies. The acoustic receiving units 11, 12 are used to filter acoustic signals and convert the acoustic signals into electrical signals. A differential amplifier 13 connected to the two acoustic receiving units 11, 12 amplifies a difference between the electrical signals transmitted from the acoustic receiving units 11, 12. By adjusting the resonant frequencies of the acoustic receiving units 11, 12, a bandpass filter 32 can be set to only pass acoustic signals that falls within a predetermined frequency range.

Each bandpass filter 32 in the acoustic signal input device 22 is connected to a series of amplifying elements, each of which is connected to a separate on/off switch. Each amplifying element in the series of amplifying elements has a different amplification level. The on/off switches operate in such a way that only one switch in a series may be switched on at any given time, and the switch that is switched on indicates a selected amplifying element. The electrical signals from the bandpass filter 32 will be magnified by the amplification level of the selected amplifying element. Each channel has an amplification level independent of the amplification level of other channels. By using the switches to adjust the amplification of different channels, a wearer of the hearing aid 20 may alter the operation of the hearing aid 20 to better suit the wearer's specific needs.

For example, assume that for the amplifying element array 30 each first-order amplifying element A1 has an amplification level of 1× (no amplification), each second-order amplifying element A2 has an amplification level of 2×, each third-order amplifying element A3 has an amplification level of 3×, and each fourth-order amplifying element A4 has an amplification level of 4×. If a first switch S11 connected to a first bandpass filter f1 is on, then the first-order amplifying element M11 is active, and the total amplification of the electrical signals in the 800-1200 Hz range is 1×. If a second switch S22 connected to a second bandpass filter f2 is on then a second-order amplifying element M22 is active, and the total amplification of the electrical signals in the 1200-2000 Hz range is 2×. If a third switch S33 connected to a third bandpass filter f3 is on, then a third-order amplifying element M33 is active, and the total amplification of the electrical signals in the 2000-2800 Hz range is 3×. If a fourth switch S44 connected a fourth bandpass filter f4 is on, then a fourth-order amplifying element M44 is active, and the total amplification of the electrical signals in the 2800-3500 Hz range is 4×. In the examples shown in FIG. 3 and FIG. 4, there are four amplifying elements for each channel, however this should not be interpreted as a limit on the present invention.

During operation, acoustic signals enter the acoustic signal input device 22. The bandpass filters 32 create distinct channels by only passing specific frequency ranges of the acoustic signal and converting the acoustic signal into an electrical signal. Each channel can receive a different amplification level according to the settings of the switches in the amplifying element array 30. The electrical signals are then passed to the amplifier 24. The amplifier 24 amplifies the electrical signals and passes them to the acoustic signal output device 26. The acoustic signal output device 26 amplifies the electrical signals in each channel according to the settings of the switches in the amplifying element array 40. Finally, the electrical signals are transformed into acoustic signals and played out of the acoustic signal output device 26.

The amplification levels of the acoustic signal input device 22, the amplifier 24, and the acoustic signal output device 26, are cumulative. For example, assume that the amplification level of the acoustic signal input device 22 for the 2000-2800 Hz channel is 3×, the amplifier 24 amplifies all signals at an amplification level of 2×, and the amplification level of the acoustic signal output device 26 for the 2000-2800 Hz channel is 4×. The total amplification of signals in the 2000-2800 Hz channel will be 24×. The total amplification of any one channel is independent of the total amplification level of the other channels.

In a second embodiment of the hearing aid device 20 of the present invention, the acoustic signal input device 22 comprises a plurality of bandpass filters 32 for each channel. Each bandpass filter 32 comprises a differential amplifier 13, and bandpass filters 32 in the same channel have differential amplifiers 13 with different amplification levels. The bandpass filters 32 are connected to a plurality of switches so that each band pass filter 32 is connected a switch that controls the on and off of the bandpass filter 32 to which it is connected. The switches are arranged in such a way that only one bandpass filter 32 may be turned on at any given time. In such an embodiment, the amplification of each channel may be selected by turning on the bandpass filter 32 with the desired amplification level for that channel.

In a third embodiment of the hearing aid device 20 of the present invention, the acoustic signal output device 26 comprises only one amplification element for each channel. The amplification element is a frequency-specific amplifier, that is, the amplification level of the amplification element is greatest for a specific frequency range corresponding to a frequency range of the electrical signals carried by the channel to which the amplification element is connected. In such an embodiment, the characteristics of the frequency-specific amplifier serve to eliminate noise in each of the channels.

Due to the small scale of the hearing aid device 20 of the present invention, Compared to the prior art hearing aid 10, the hearing aid 20 of the present invention can separate input acoustic signal into several distinct frequency ranges. By separating input acoustic signal into several frequency ranges, the wearer of the hearing aid 20 according to the present invention can customize the settings of the hearing aid 20 to correspond to the wearer's individual impairment. The present invention allows the wearer to adjust the amplification level of the hearing aid 20 to compensate for the wearer's level hearing loss. The present invention also allows the wearer to set different amplification levels for each frequency range so as to only amplify the frequency ranges at which the wearer experiences difficulty with hearing.

The bandpass filter 32 of the present invention can comprise called an amplitude-tunable filter. An amplitude-tunable filter can amplify sound by changing the mechanical parameters, such as the geometry and boundary condition, of the hearing aid device 20. Due to the small size of the mechanical parts of the present invention, a micromachining fabrication process can be used in the manufacturing process of the hearing aid device 20. The acoustic signal input device 22, the acoustic signal output device 26, or any part thereof may be manufactured using micromachining fabrication methods.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An acoustic signal input device comprising:
an input for inputting acoustic signals;
a plurality of bandpass filters each for passing acoustic signals with frequencies within a predetermined frequency range, and transforming the acoustic signals into electrical signals and amplifying the electrical signals; and
a plurality of switches each connected to a corresponding bandpass filter for controlling on and off of the bandpass filter;
wherein the switches are capable of being selectively turned on so as to amplify transformed electrical signals within different frequency ranges at different amplifications.

2. The acoustic signal input device of claim 1 wherein each of the bandpass filters comprises:
two signal transformation units for transforming acoustic signals into electrical signals, the signal transformation units having different resonant frequencies for filtering the electrical signals; and
a differential amplifier electrically connected to the signal transformation units for amplifying a difference between the electrical signals transmitted from the signal transformation units.

3. The acoustic signal input device of claim 1 wherein each of the bandpass filters is an amplitude-tunable filter capable of changing amplification of electrical signals.

4. The acoustic signal input device of claim 1 being connected to an amplifier for further amplifying the electrical signals transmitted from the acoustic signal input device.

5. The acoustic signal input device of claim 1 wherein the plurality of bandpass filters are formed by performing a micromachining fabrication process.

6. The acoustic signal input device of claim 1 being a microphone.

7. An acoustic signal input device comprising:
an input for inputting acoustic signals;
a plurality of bandpass filters each for passing acoustic signals with frequencies within a predetermined frequency range and transforming the acoustic signals into electrical signals;
a plurality of amplification circuits connected to the bandpass filters for amplifying electrical signals transmitted from the bandpass filters; and
a plurality of switches each connected to a corresponding amplification circuit for controlling on and off of the amplification circuit;
wherein the switches are capable of being controlled to selectively turn on amplification circuits so as to amplify electrical signals within different frequency ranges at different amplifications.

8. The acoustic signal input device of claim 7 wherein each of the bandpass filters comprises:
two signal transformation units for transforming acoustic signals into electrical signals, the signal transformation units having different resonant frequencies for filtering the electrical signals; and
a differential amplifier electrically connected to the signal transformation units for amplifying a difference between the electrical signals transmitted from the signal transformation units.

9. The acoustic signal input device of claim 7 being connected to an amplifier for further amplifying the electrical signals transmitted from the acoustic signal input device.

10. The acoustic signal input device of claim 9 wherein the amplifier is connected to an acoustic signal output device for transforming the electrical signals transmitted from the amplifier into acoustic signals and outputting the acoustic signals.

11. The acoustic signal input device of claim 7 wherein the plurality of bandpass filters are formed by performing a micromachining fabrication process.

12. The acoustic signal input device of claim 7 being a microphone.

13. An acoustic signal output device electrically connected to a signal source, the signal source comprising a plurality of channels for transmitting electrical signals within different frequency ranges, the acoustic signal output device comprising:
a plurality of amplifying elements connected to different channels of the signal source for amplifying electrical signals at different amplifications and transforming amplified electrical signals into acoustic signals.

14. The acoustic signal output device of claim 13 wherein each of the amplifying elements has a greatest amplification for electrical signals within a frequency range corresponding to a frequency range of a channel that is connected to the amplifying element.

15. The acoustic signal output device of claim 13 further comprising:
a plurality of switches each connected to a corresponding amplifying element for controlling on and off of the amplifying element;
wherein the switches are capable of being controlled to selectively turn on amplifying elements so as to amplify electrical signals within different frequency ranges at different amplifications.

16. The acoustic signal output device of claim 13 wherein the signal source is an amplifier, the amplifier amplifying the electrical signals before the electrical signals are transmitted to the acoustic signal output device.

17. The acoustic signal output device of claim 13 wherein the signal source is connected to an acoustic signal input device for receiving electrical signals from the acoustic signal input device.

18. The acoustic signal output device of claim 13 being a speaker.

19. The acoustic signal output device of claim 13 wherein each of the amplifying elements comprises a signal transformation unit for transforming amplified electrical signals into acoustic signals.

20. The acoustic signal output device of claim 13 being formed by performing a micromachining fabrication process.
